(19) United States
(12) Patent Application Publication
(10) Pub. No.: US 2012/0123733 A1
(43) Pub. Date: May 17, 2012

(54) METHOD SYSTEM AND COMPUTER READABLE MEDIA FOR HUMAN MOVEMENT RECOGNITION

(75) Inventors: Chi Chung LO, Zhuqi Township (TW); Tsung Heng Wu, Pingtung City (TW); Chao Yu Chen, Kaohsiung City (TW); Lun Chia Kuo, Taichung City (TW); Yu Chee Tseng, Hsinchu City (TW)

(73) Assignees: NATIONAL CHIAO TUNG UNIVERSITY, Hsinchu (TW); INDUSTRIAL TECHNOLOGY RESEARCH INSTITUTE, Chutung (TW)

(21) Appl. No.: 13/235,611

(22) Filed: Sep. 19, 2011

(30) Foreign Application Priority Data
Nov. 11, 2010 (TW) 099138777

(51) Int. Cl. G06F 15/00; G01P 15/00

(52) U.S. Cl. 702/141

(57) ABSTRACT

A method for human movement recognition comprises the steps of: retrieving successive measuring data for human movement recognition from an inertial measurement unit; dividing the successive measuring data to generate at least a human movement pattern waveform if the successive measuring data conforms to a specific human movement pattern; quantifying the at least a human movement pattern waveform to generate at least a human movement sequence; and determining a human movement corresponding to the inertial measurement unit by comparing the at least a human movement sequence and a plurality of reference human movement sequences.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure relates to a method, system and computer readable media for human movement recognition, and particularly to a method, system and computer readable media for human movement recognition using an inertial measurement unit (IMU).

2. Description of Related Art Including Information Disclosed Under 37 CFR 1.97 and 37 CFR 1.98

Currently, the most well-known positioning system is the global positioning system (GPS), which uses satellite technology, and is widely installed in automobile and mobile apparatus applications. However, since GPS technology requires transmission and reception of satellite signals, it is only suitable for outdoor usage. When used indoors, GPS may suffer from poor signal reception. Therefore, a major goal of academics and industry is to develop a practical positioning system that can be used indoors.

Current research papers show that positioning systems using a pattern comparison algorithm can provide acceptable positioning results with a margin of error of only a few meters caused by the instability of the wireless signal, which causes shifting of the positioning results. When the positioning system is applied in a multi-floor building, a vertical shifting between floors corresponds to an unacceptable error. To avoid such error, one approach is to obtain the user's current floor information in advance, and update the information only when a specific human movement occurs. In this way, the positioning results are fixed to a certain floor such that the vertical shifting between floors is eliminated, and the accuracy of the positioning system is enhanced.

Current mobile apparatuses installed with IMU are becoming increasingly popular. If such IMU can be used for the purpose of human movement recognition, any other costs for the purpose of human movement recognition can be saved. Accordingly, there is a need to design a method and system for human movement recognition which uses IMU such that the method and system for human movement recognition can be easily integrated into the modern mobile apparatuses.

### BRIEF SUMMARY OF THE INVENTION

One exemplary embodiment of this disclosure discloses a method for human movement recognition, comprising the steps of: retrieving successive measuring data for human movement recognition from an inertial measurement unit; dividing the successive measuring data to generate at least a human movement pattern waveform if the successive measuring data conforms to a specific human movement pattern; quantifying the at least a human movement pattern waveform to generate at least a human movement sequence; and determining a human movement corresponding to the inertial measurement unit by comparing the at least a human movement sequence and a plurality of reference human movement sequences.

Another embodiment of this disclosure discloses a system for human movement recognition. The system for human movement recognition comprises an IMU, a pattern retrieving unit and a pattern recognition unit. The IMU is configured to provide successive measuring data of a human movement. The pattern retrieving unit is configured to divide the successive measuring data to generate at least a human movement pattern waveform and quantify the at least a human movement pattern waveform to generate at least a human movement sequence. The pattern recognition unit is configured to compare the at least a human movement sequence and a plurality of reference human movement sequences to determine the human movement.

Another embodiment of this disclosure discloses computer readable media having program instructions for human movement recognition, the computer readable media comprising programming instructions for retrieving successive measuring data for human movement recognition from an inertial measurement unit; programming instructions for dividing the successive measuring data to generate at least a human movement pattern waveform if the successive measuring data conforms to a specific human movement pattern; programming instructions for quantifying the at least a human movement pattern waveform to generate at least a human movement sequence; and programming instructions for determining a human movement corresponding to the inertial measurement unit by comparing the at least a human movement sequence and a plurality of reference human movement sequences.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the disclosure.

FIG. 1 shows a system for human movement recognition according to an exemplary embodiment of this disclosure;

FIG. 2 shows the flowchart of a method for human movement recognition according to an exemplary embodiment of this disclosure;

FIG. 3 shows the waveform of successive measuring data provided by an IMU when a user is riding in an elevator according to an exemplary embodiment of this disclosure;

FIG. 4 shows the waveform of successive measuring data provided by an IMU when a user is walking up or down stairs according to an exemplary embodiment of this disclosure;

FIG. 5 shows a human movement pattern waveform and the corresponding human movement sequence according to an exemplary embodiment of this disclosure;

FIG. 6 shows a human movement pattern waveform and the corresponding human movement sequence according to another exemplary embodiment of this disclosure; and

FIG. 7 shows a human movement pattern waveform and the corresponding human movement sequence according to yet another exemplary embodiment of this disclosure.

### DETAILED DESCRIPTION OF THE INVENTION

This disclosure provides exemplary embodiments of a method and system for human movement recognition. In the exemplary embodiments of this disclosure, an IMU is used for the recognition of human movement based on a wireless detection network. However, the method and system for human movement recognition of the exemplary embodiments of this disclosure are not limited to applications of wireless detection network. The method and system for human movement recognition of the exemplary embodiments of this disclosure can recognize users moving between floors, including but not limited to riding in an elevator and walking up or down stairs.

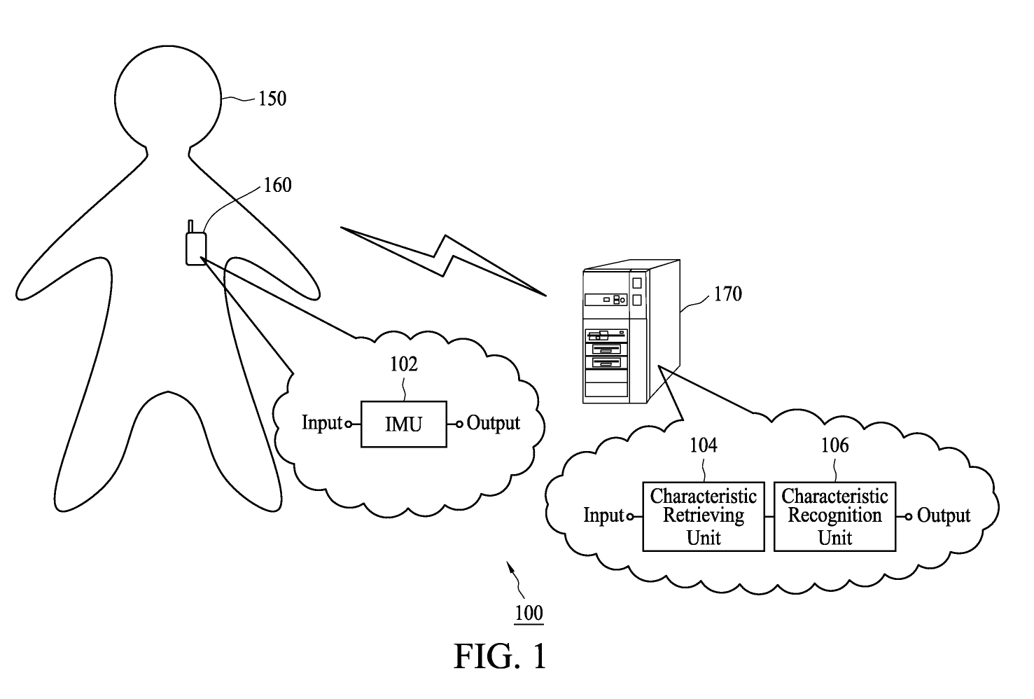

FIG. 1 shows a system for human movement recognition according to an exemplary embodiment of this disclosure. As shown in FIG. 1, the system 100 comprises an IMU 102, a pattern retrieving unit 104 and a pattern recognition unit 106. The IMU 10 is installed on a mobile apparatus 160 carried by a user 150. The pattern retrieving unit 104 and the pattern recognition unit 106 are implemented by software executed by a computer apparatus of a wireless network apparatus 170. The IMU 102 is capable of performing wireless communication with the pattern retrieving unit 104 and the pattern recognition unit 106. The IMU 102 is configured to output successive measuring data of a human movement, i.e. the successive measuring data of the behavior of the user 150. The pattern retrieving unit 104 is configured to divide the successive measuring data to generate at least a human movement pattern waveform and quantify the at least a human movement pattern waveform to generate at least a human movement sequence. The pattern recognition unit 106 is configured to compare the at least a human movement sequence with a plurality of reference human movement sequences to determine the human movement of the user 150.

In this exemplary embodiment, the IMU 102 is an accelerometer, an electronic compass, an angular accelerometer, or the combination thereof. The successive measuring data is comprised of values of tri-axial acceleration, tri-axial Euler angle, tri-axial angular acceleration, or the combination thereof. The system 100 can determine whether the user 150 is riding in an elevator or walking up or down stairs.

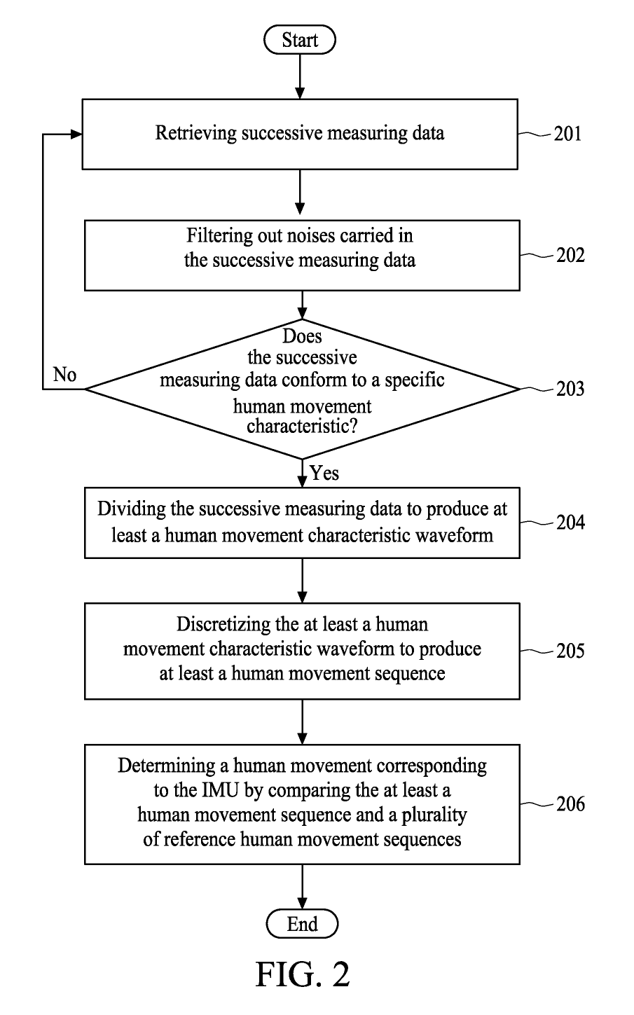

FIG. 2 shows the flowchart of a method for human movement recognition according to an exemplary embodiment of this disclosure. In step 201, successive measuring data from an inertial measurement unit for human movement recognition is retrieved, and step 202 is executed. In step 202, noises carried in the successive measuring data are filtered out, and step 203 is executed. In step 203, it is determined whether the successive measuring data conforms to a specific human movement pattern. If the successive measuring data conforms to a specific human movement pattern, step 204 is executed; otherwise, step 201 is executed. In step 204, at least a human movement pattern waveform is generated by dividing the successive measuring data, and step 205 is executed. In step 205, at least a human movement sequence is generated by quantifying the at least a human movement pattern waveform, and step 206 is executed. In step 206, the at least a human movement sequence and a plurality of reference human movement sequences are compared to determine a human movement corresponding to the inertial measurement unit.

The following illustrates applying the method for human movement recognition shown in FIG. 2 to the system for human movement recognition shown in FIG. 1. In step 201, the IMU 102 outputs successive measuring data of the human movement of the user 150 and transmits the successive measuring data to the pattern retrieving unit 104. In step 202, the pattern retrieving unit 104 filters out noises carried in the successive measuring data. In this exemplary embodiment, a low-pass filter, which can be represented by the function: a′ᵢ=α×aᵢ+(1−α)×a′ᵢ₋₁, is used to filter the successive measuring data, wherein aᵢ represents the element before being processed by the low-pass filter, a′ᵢ represents the i^{th} element after being processed by the low-pass filter, a′ᵢ₋₁ represents the (i-1)^{th} element after being processed by the low-pass filter, and α is a parameter controlling the filtering frequency. Ordinarily, the frequency of the fluctuation caused by a user's walking behavior is greater than the frequency of the fluctuation caused by a user riding in an elevator. Accordingly, by using the low-pass filter, the system 100 is capable of detecting the human movement pattern waveform of a user riding in an elevator even if the user is moving inside the elevator while riding in the elevator.

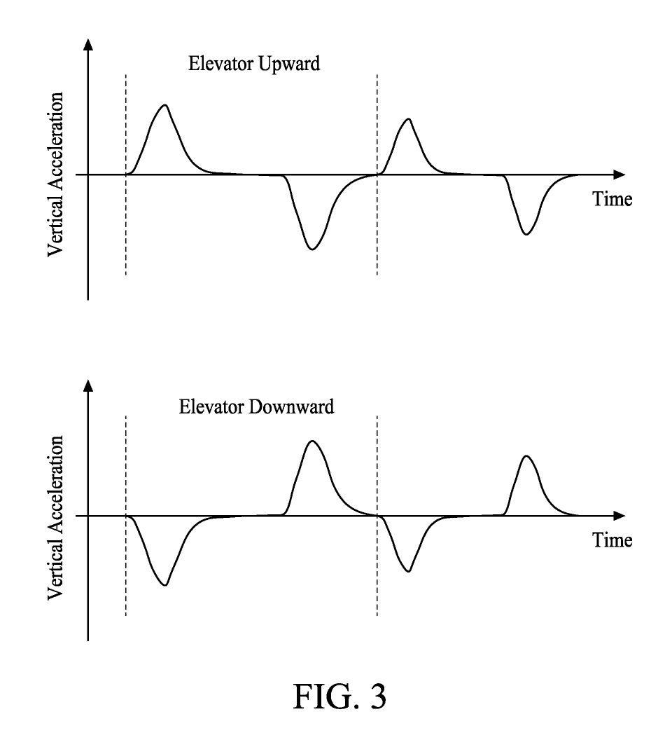

In step 203, the pattern retrieving unit 104 determines whether the successive measuring data conforms to a specific human movement pattern. Ordinarily, if the user 150 is riding in an upward-moving elevator, the waveform of a tri-axial acceleration value of the successive measuring data exhibits a convex-horizontal-concave manner. On the other hand, if the user 150 is riding in a downward-moving elevator, the waveform of a tri-axial acceleration value of the successive measuring data exhibits a concave-horizontal-convex manner. FIG. 3 shows the waveform of a tri-axial acceleration value of the successive measuring data provided by the IMU 102 when the user 150 is riding in an elevator. Accordingly, if a waveform of a tri-axial acceleration value of the successive measuring data exhibits a convex-horizontal-concave manner or a concave-horizontal-convex manner, then the pattern retrieving unit 104 determines that the successive measuring data conforms to an elevator-riding behavior pattern. In this exemplary embodiment, an upper threshold and a lower threshold can be further utilized such that only when the tri-axial acceleration of the successive measuring data has a value greater than the upper threshold and a value smaller than the lower threshold will the pattern retrieving unit 104 determine that the successive measuring data conforms to a specific human movement pattern.

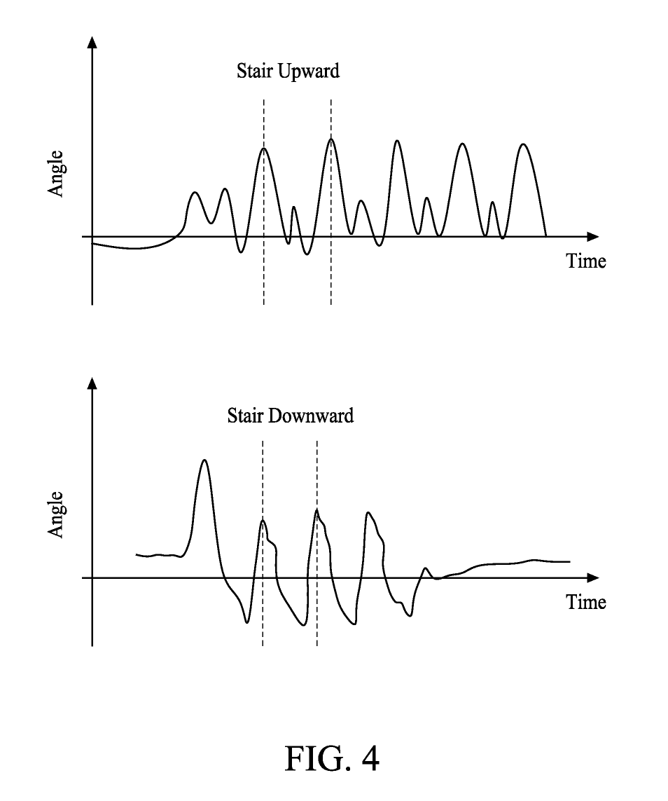

On the other hand, if the user 150 is walking up or down stairs, an angle value of the successive measuring data will periodically exceed a threshold, as shown in FIG. 4. Accordingly, if an angle value of the successive measuring data periodically exceeds a threshold, the pattern retrieving unit 104 determines that the successive measuring data conforms to a stair-walking behavior pattern.

In step 204, the pattern retrieving unit 104 divides the successive measuring data to generate at least a human movement pattern waveform. If the pattern retrieving unit 104 determines that the successive measuring data conforms to an elevator-riding behavior pattern, the pattern retrieving unit 10 divides the successive measuring data to at least a human movement pattern waveform by taking a waveform in a convex-horizontal-concave manner or in a concave-horizontal-convex manner as a basic unit, as shown in FIG. 3. On the other hand, if the pattern retrieving unit 104 determines that the successive measuring data conforms to a stair-walking behavior pattern, the pattern retrieving unit 10 divides the successive measuring data to at least a human movement pattern waveform such that each of both ends of each human movement pattern waveform has a maximum value, as shown in FIG. 4.

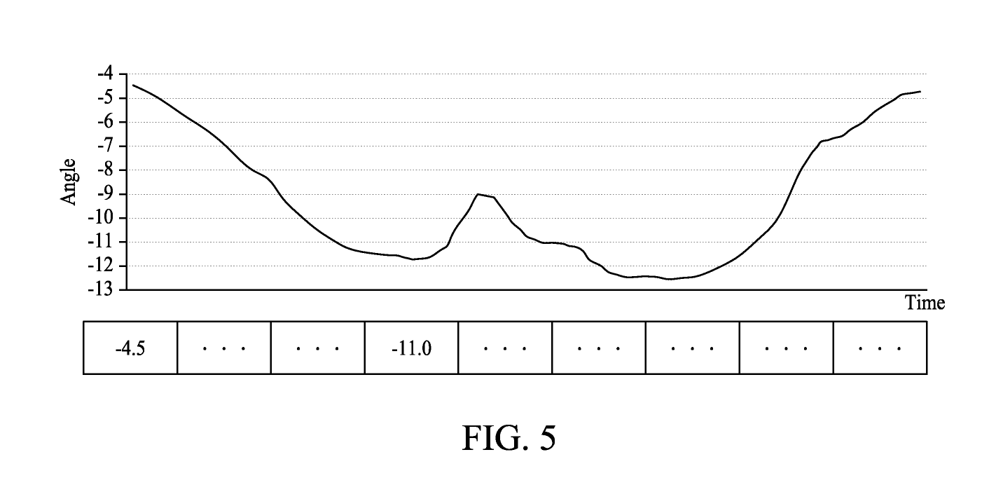

In step 205, at least a human movement sequence is generated by quantifying the at least a human movement pattern waveform. In an exemplary embodiment of this disclosure, the pattern retrieving unit 104 uses a full pattern sampling algorithm, which samples a human movement pattern waveform to generate a human movement sequence. As shown in FIG. 5, the upper drawing shows a human movement pattern waveform, and the lower drawing shows the corresponding human movement sequence.

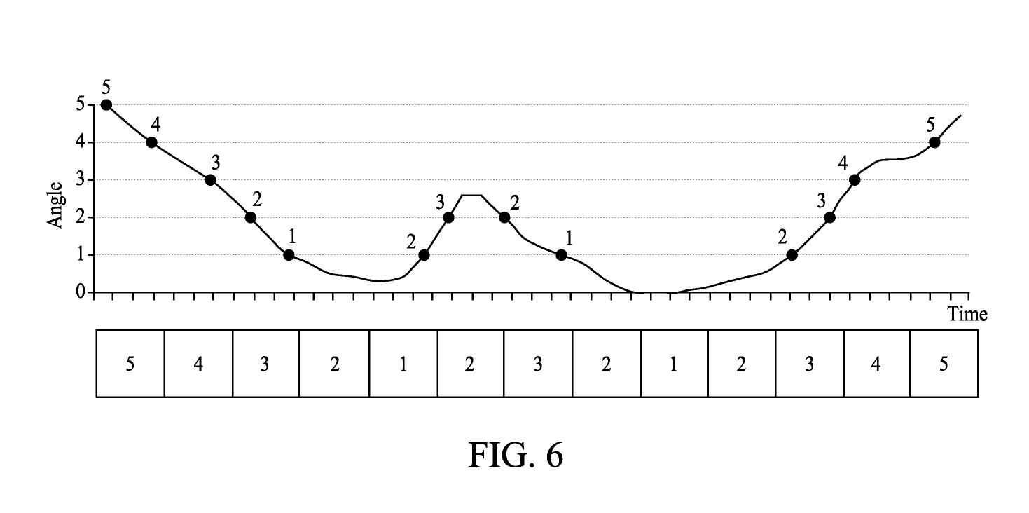

In another exemplary embodiment of this disclosure, the pattern retrieving unit 104 uses a boundary discrete pattern sampling algorithm, which takes the maximum and minimum values of a human movement pattern waveform as the maximum and minimum values of a corresponding human movement sequence, and then the human movement pattern waveform is divided into a plurality of value regions. Next, the human movement pattern waveform is quantified according to the value regions, and the human movement sequence records the corresponding values when the human movement pattern waveform moves from one value region to another value region. FIG. 6 shows another human movement pattern waveform and the corresponding human movement sequence. As shown in FIG. 6, the minimum of the human movement pattern waveform is set as one, the maximum of the human movement pattern waveform is set as five, and the human movement pattern waveform is divided into five value regions accordingly. In addition, as shown in FIG. 6, the human movement sequence records only when the human movement pattern waveform moves from one value region to another value region. Therefore, successive identical values do not exist in the human movement sequence.

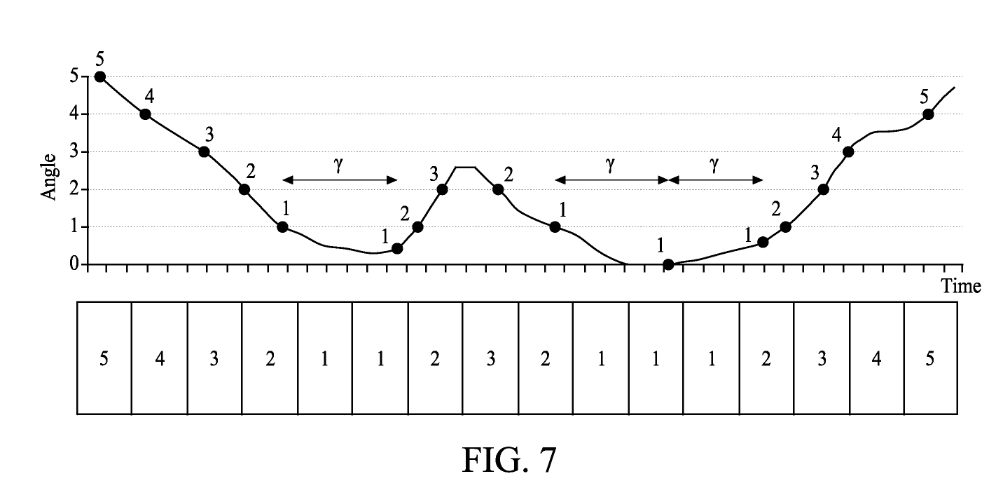

In yet another exemplary embodiment of this disclosure, the pattern retrieving unit 104 uses a time discrete pattern sampling algorithm, which takes the maximum and minimum values of a human movement pattern waveform as the maximum and minimum values of a corresponding human movement sequence, and then the human movement pattern waveform is divided into a plurality of value regions. Next, the human movement pattern waveform is quantified according to the value regions, and the human movement sequence records the corresponding values when the human movement pattern waveform moves from one value region to another value region, or when the human movement pattern waveform remains in a value region over a predetermined period of time. FIG. 7 shows another human movement pattern waveform and the corresponding human movement sequence. As shown in FIG. 7, the minimum of the human movement pattern waveform is set as one, the maximum of the human movement pattern waveform is set as five, and the human movement pattern waveform is divided into five value regions accordingly. In addition, as shown in FIG. 7, the human movement sequence records only when the human movement pattern waveform moves from one value region to another value region, or when the human movement pattern waveform remains in a value region over a predetermined period of time γ.

In step 206, the pattern recognition unit 106 compares the at least a human movement sequence and a plurality of reference human movement sequences to determine a human movement of the user 150 corresponding to the IMU 102. In an exemplary embodiment of this disclosure, the reference human movement sequence is determined according to stored elevator-riding behavior patterns and stair-walking behavior patterns of a training step at the initialization setup.

In an exemplary embodiment of this disclosure, the pattern recognition unit 106 uses a pattern-matching algorithm for the comparison of the at least a human movement sequence and the plurality of reference human movement sequences. The pattern-matching algorithm sums up the differences of a human movement sequence and a reference human movement sequence, and determines the human movement of the user 150 accordingly. The pattern-matching algorithm is represented by the function

Err(T, C)=Σᵢ₌₀^{k}|T[i]−C[i]|

wherein Err(T, C) is the total difference of the human movement sequence and a reference human movement sequence, C[i] is the human movement sequence, T[i] is the reference human movement sequence, and k is the length of the human movement sequence and the reference human movement sequence.

In an exemplary embodiment of this disclosure, if the length of the human movement sequence is different from the length of the reference human movement sequence, or if there is an offset between the human movement sequence and the reference human movement sequence, the human movement sequence can be shifted to be aligned with the reference human movement sequence, and an interpolation computation can be executed to fill the human movement sequence such that the lengths of the human movement sequence and the reference human movement sequence are the same. Next, the pattern recognition unit 106 compares a plurality of Err(T, C) according to different reference human movement sequences, and determines the human movement of the user 150 corresponding to the reference human movement sequence with the smallest Err(T, C).

In an exemplary embodiment of this disclosure, the pattern recognition unit 106 uses a longest-common-substring algorithm for the comparison of the at least a human movement sequence and the plurality of reference human movement sequences. The longest-common-substring algorithm determines the similarity between a human movement sequence and a reference human movement sequence according to the ratio of the length of the longest common substring of the human movement sequence and the reference human movement sequence to the length of the human movement sequence and the reference human movement sequence. The longest-common-substring algorithm is represented by the function

$$S = \frac{2 \cdot \vert LCS ( {T}^{′} , {C}^{′} ) \vert}{\vert {T}^{′} \vert + \vert {C}^{′} \vert}$$

wherein C′ is the human movement sequence, T′ is the reference human movement sequence, S is the similarity between the human movement sequence and the reference human movement sequence, and LCS is the computation of the longest-common-substring algorithm. For instance, if a human movement sequence is [5, 4, 3, 2, 1, 2, 3, 2, 1, 1, 1, 2, 3, 4, 5], and a reference human movement sequence is [5, 4, 3, 2, 1, 1, 2, 3, 2, 1, 1, 1, 2, 3, 4], then the longest-common-substring of these two sequences is [5, 4, 3, 2, 1, 2, 3, 2, 1, 1, 1, 2, 3, 4], and the similarity S between the human movement sequence and the reference human movement sequence is 2*14/(15+15)=0.93. Next, the pattern recognition unit 106 compares a plurality of the similarities S between the human movement sequence and a plurality of reference human movement sequences and determines the human movement of the user 150 corresponding to the reference human movement sequence with the greatest similarity S.

In an exemplary embodiment of this disclosure, the pattern recognition unit 106 uses a longest-common-subsequence algorithm for the comparison of the at least a human movement sequence and the plurality of reference human movement sequences. The longest-common-subsequence algorithm determines the similarity between a human movement sequence and a reference human movement sequence according to the ratio of the length of the longest common sequence of the human movement sequence and the reference human movement sequence to the length of the human movement sequence and the reference human movement sequence. The longest-common-subsequence algorithm is represented by the function

$$S = \frac{2 \cdot \vert LCS ( {T}^{″} , {C}^{″} ) \vert}{\vert {T}^{″} \vert + \vert {C}^{″} \vert}$$

wherein C′ is the human movement sequence, T′ is the reference human movement sequence, S is the similarity between the human movement sequence and the reference human movement sequence, and LCS is the computation of the longest-common-subsequence algorithm. For instance, if a human movement sequence is [5, 4, 3, 2, 1, 2, 3, 2, 1, 1, 1, 2, 3, 4, 5], and a reference human movement sequence is [5, 4, 3, 2, 1, 1, 2, 3, 2, 1, 1, 1, 2, 3, 4], then the longest-common-sequence of these two sequences is [2, 3, 2, 1, 1, 1, 2, 3, 4], and the similarity S between the human movement sequence and the reference human movement sequence is 2*9/(15+15)=0.6. Next, the pattern recognition unit 106 compares a plurality of the similarities S between the human movement sequence and a plurality of reference human movement sequences and determines the human movement of the user 150 corresponding to the reference human movement sequence with the greatest similarity S.

Another embodiment of this disclosure discloses computer readable media having program instructions for human movement recognition, the computer readable media comprising programming instructions for retrieving successive measuring data for human movement recognition from an inertial measurement unit; programming instructions for dividing the successive measuring data to generate at least a human movement pattern waveform if the successive measuring data conforms to a specific human movement pattern; programming instructions for quantifying the at least a human movement pattern waveform to generate at least a human movement sequence; and programming instructions for determining a human movement corresponding to the inertial measurement unit by comparing the at least a human movement sequence and a plurality of reference human movement sequences. The related details are as the above embodiments.

In conclusion, the method and system for human movement recognition of this disclosure uses an IMU to detect the human movement. Through the steps of retrieving, dividing and comparing, a user's human movement can be determined. Accordingly, the method and system for human movement recognition of this disclosure can be integrated into various modern mobile apparatus installed with IMUs.

The above-described exemplary embodiments are intended to be illustrative only. Those skilled in the art may devise numerous alternative embodiments without departing from the scope of the following claims.

We claim:

1. A method for human movement recognition, comprising the steps of:
retrieving successive measuring data for human movement recognition from an inertial measurement unit;
dividing the successive measuring data to generate at least a human movement pattern waveform if the successive measuring data conforms to a specific human movement pattern;
quantifying the at least a human movement pattern waveform to generate at least a human movement sequence; and
determining a human movement corresponding to the inertial measurement unit by comparing the at least a human movement sequence and a plurality of reference human movement sequences.

2. The method of claim 1, further comprising the step of:
reducing noises carried in the successive measuring data by filtering the successive measuring data.

3. The method of claim 1, wherein the dividing step comprises the sub-steps of:
determining that the successive measuring data conforms to an elevator-riding behavior pattern if a tri-axial acceleration value waveform of the successive measuring data exhibits a convex-horizontal-concave form or a concave-horizontal-convex form; and
dividing the successive measuring data to generate at least a human movement pattern waveform such that each human movement pattern waveform has one convex-horizontal-concave form or one concave-horizontal-convex form.

4. The method of claim 1, wherein the dividing step comprises the sub-steps of:
determining that the successive measuring data conforms to a stair-walking behavior pattern if an angle value of the successive measuring data periodically exceeds a threshold; and
dividing the successive measuring data to generate at least a human movement pattern waveform such that a maximum value exists at each of both ends of each human movement pattern waveform.

5. The method of claim 1, wherein the quantifying step comprises the sub-step of:
sampling a human movement pattern waveform to generate a human movement sequence.

6. The method of claim 1, wherein the quantifying step comprises the sub-steps of:
taking the maximum and minimum values of a human movement pattern waveform as the maximum and minimum values of a corresponding human movement sequence, and dividing the human movement pattern waveform into a plurality of value regions accordingly; and
quantifying the human movement pattern waveform according to the value regions and recording corresponding values of the human movement pattern waveform when it moves from one value region to another value region as values of the human movement sequence.

7. The method of claim 1, wherein the quantifying step comprises the sub-steps of:
taking the maximum and minimum values of a human movement pattern waveform as the maximum and minimum values of a corresponding human movement sequence, and dividing the human movement pattern waveform into a plurality of value regions accordingly; and
quantifying the human movement pattern waveform according to the value regions and recording corresponding values of the human movement pattern waveform when it moves from one value region to another value region and when it remains in a value region over a predetermined period of time as values of the human movement sequence.

8. The method of claim 1, wherein the determining step comprises the sub-step of summing up the differences of a human movement sequence and a reference human movement sequence, and determining the human movement accordingly.

9. The method of claim 8, wherein the determining step comprises the sub-step of shifting a human movement sequence to be aligned with a reference human movement sequence and executing an interpolation computation to fill the human movement sequence such that the lengths of the human movement sequence and the reference human movement sequence are the same.

10. The method of claim 1, wherein the determining step comprises the sub-step of determining the human movement according to a longest common substring between a human movement sequence and a reference human movement sequence.

11. The method of claim 1, wherein the determining step comprises the sub-step of determining the human movement according to a longest common subsequence between a human movement sequence and a reference human movement sequence.

12. The method of claim 1, wherein the successive measuring data comprises values of tri-axial acceleration, tri-axial Euler angle, tri-axial angular acceleration, or the combination thereof.

13. The method of claim 1, wherein the inertial measurement unit is an accelerometer, an electronic compass, an angular accelerometer, or the combination thereof.

14. The method of claim 1, wherein the plurality of reference human movement sequences comprise sequences of riding in an elevator and sequences of walking up or down stairs.

15. A system for human movement recognition, comprising:
an inertial measurement unit, configured to provide successive measuring data of a human movement;
a pattern retrieving unit, configured to divide the successive measuring data to generate at least a human movement pattern waveform and quantify the at least a human movement pattern waveform to generate at least a human movement sequence; and
a pattern recognition unit, configured to compare the at least a human movement sequence and a plurality of reference human movement sequences to determine the human movement.

16. The system of claim 15, wherein the pattern retrieving unit is configured to divide the successive measuring data when the successive measuring data conforms to an elevator-riding behavior pattern or a stair-walking behavior pattern.

17. The system of claim 15, wherein the pattern recognition unit is configured to compare the at least a human movement sequence and a plurality of reference human movement sequences by a pattern-matching algorithm, which sums up differences between a human movement sequence and a reference human movement sequence.

18. The system of claim 15, wherein the pattern recognition unit is configured to compare the at least a human movement sequence and a plurality of reference human movement sequences by a longest-common-substring algorithm, which determines similarity between a human movement sequence and a reference human movement sequence according to the ratio of the length of a longest common substring of the human movement sequence and a reference human movement sequence to the length of the human movement sequence and a reference human movement sequence.

19. The system of claim 15, wherein the pattern recognition unit is configured to compare the at least a human movement sequence and a plurality of reference human movement sequences by a longest-common-subsequence algorithm, which determines similarity between a human movement sequence and a reference human movement sequence according to the ratio of the length of a longest common subsequence of the human movement sequence and a reference human movement sequence to the length of the human movement sequence and a reference human movement sequence.

20. The system of claim 15, wherein the plurality of reference human movement sequences comprise sequences of riding in an elevator and sequences of walking up or down stairs.

21. The system of claim 15, wherein the successive measuring data comprises values of tri-axial acceleration, tri-axial Euler angle, tri-axial angular acceleration, or the combination thereof.

22. The system of claim 15, wherein the inertial measurement unit is an accelerometer, an electronic compass, an angular accelerometer, or the combination thereof.

23. A computer readable media having program instructions for human movement recognition, the computer readable media comprising:
programming instructions for retrieving successive measuring data for human movement recognition from an inertial measurement unit;
programming instructions for dividing the successive measuring data to generate at least a human movement pattern waveform if the successive measuring data conforms to a specific human movement pattern;
programming instructions for quantifying the at least a human movement pattern waveform to generate at least a human movement sequence; and
programming instructions for determining a human movement corresponding to the inertial measurement unit by comparing the at least a human movement sequence and a plurality of reference human movement sequences.

24. The computer readable media of claim 23, further comprising:
programming instructions for reducing noises carried in the successive measuring data by filtering the successive measuring data.

25. The computer readable media of claim 23, wherein the programming instructions for dividing the successive measuring data comprises:
programming instructions for determining that the successive measuring data conforms to an elevator-riding behavior pattern if a tri-axial acceleration value waveform of the successive measuring data exhibits a convex-horizontal-concave form or a concave-horizontal-convex form; and
programming instructions for dividing the successive measuring data to generate at least a human movement pattern waveform such that each human movement pattern waveform has one convex-horizontal-concave form or one concave-horizontal-convex form.

26. The computer readable media of claim 23, wherein the programming instructions for dividing the successive measuring data comprises:
programming instructions for determining that the successive measuring data conforms to a stair-walking behavior pattern if an angle value of the successive measuring data periodically exceeds a threshold; and
programming instructions for dividing the successive measuring data to generate at least a human movement pattern waveform such that a maximum value exists at each of both ends of each human movement pattern waveform.

27. The computer readable media of claim 23, wherein the programming instructions for quantifying the at least a human movement pattern waveform comprises:
programming instructions for sampling a human movement pattern waveform to generate a human movement sequence.

28. The computer readable media of claim 23, wherein the programming instructions for quantifying the at least a human movement pattern waveform comprises:
programming instructions for taking the maximum and minimum values of a human movement pattern waveform as the maximum and minimum values of a corresponding human movement sequence, and dividing the human movement pattern waveform into a plurality of value regions accordingly; and
programming instructions for quantifying the human movement pattern waveform according to the value regions and recording corresponding values of the human movement pattern waveform when it moves from one value region to another value region as values of the human movement sequence.

29. The computer readable media of claim 23, wherein the programming instructions for quantifying the at least a human movement pattern waveform comprises:
programming instructions for taking the maximum and minimum values of a human movement pattern waveform as the maximum and minimum values of a corresponding human movement sequence, and dividing the human movement pattern waveform into a plurality of value regions accordingly; and
programming instructions for quantifying the human movement pattern waveform according to the value regions and recording corresponding values of the human movement pattern waveform when it moves from one value region to another value region and when it remains in a value region over a predetermined period of time as values of the human movement sequence.

30. The computer readable media of claim 23, wherein the programming instructions for determining a human movement comprises:
programming instructions for summing up the differences of a human movement sequence and a reference human movement sequence, and determining the human movement accordingly.

31. The computer readable media of claim 30, wherein the programming instructions for determining a human movement comprises:
programming instructions for shifting a human movement sequence to be aligned with a reference human movement sequence and executing an interpolation computation to fill the human movement sequence such that the lengths of the human movement sequence and the reference human movement sequence are the same.

32. The computer readable media of claim 23, wherein the programming instructions for determining a human movement comprises:
programming instructions for determining the human movement according to a longest common substring between a human movement sequence and a reference human movement sequence.

33. The computer readable media of claim 23, wherein the programming instructions for determining a human movement comprises:
programming instructions for determining the human movement according to a longest common subsequence between a human movement sequence and a reference human movement sequence.

34. The computer readable media of claim 23, wherein the successive measuring data comprises values of tri-axial acceleration, tri-axial Euler angle, tri-axial angular acceleration, or the combination thereof.

35. The computer readable media of claim 23, wherein the inertial measurement unit is an accelerometer, an electronic compass, an angular accelerometer, or the combination thereof.

36. The computer readable media of claim 23, wherein the plurality of reference human movement sequences comprise sequences of riding in an elevator and sequences of walking up or down stairs.
